(19) United States
(12) Patent Application Publication
(10) Pub. No.: US 2025/0144887 A1
(43) Pub. Date: May 8, 2025

(54) Three-Dimensional Object Printing System, Control Method Of Three-Dimensional Object Printing System, And Three-Dimensional Object Printing Apparatus

(71) Applicant: SEIKO EPSON CORPORATION, Tokyo (JP)

(72) Inventors: Yoshinori NAKAJIMA, Matsumoto (JP); Masaru KUMAGAI, Shiojiri (JP); Kohei UTSUNOMIYA, Matsumoto (JP); Yuichiro MATSUURA, Shiojiri (JP)

(21) Appl. No.: 18/934,319

(22) Filed: Nov. 1, 2024

(30) Foreign Application Priority Data
Nov. 2, 2023 (JP) 2023-188259

(51) Int. Cl. B29C 64/393; B29C 64/241; B33Y 30/00; B33Y 50/02

(52) U.S. Cl. CPC B29C 64/393; B29C 64/241; B33Y 30/00; B33Y 50/02

(57) ABSTRACT

A three-dimensional object printing system includes: a three-dimensional object printing apparatus including a print head that discharges a liquid toward a three-dimensional workpiece, and a robot that holds the print head; and a server communicatively connected to the three-dimensional object printing apparatus, the server acquires workpiece information regarding the workpiece, and generates, based on the workpiece information, a print path that is a path on which the print head moves with respect to the workpiece.

The present application is based on, and claims priority from JP Application Serial Number 2023-188259, filed Nov. 2, 2023, the disclosure of which is hereby incorporated by reference herein in its entirety. The disclosure of US 2023/0064877, published Mar. 2, 2023, is also hereby incorporated by reference herein in its entirety.

### BACKGROUND

### 1. Technical Field

The present disclosure relates to a three-dimensional object printing system, a control method of a three-dimensional object printing system, and a three-dimensional object printing apparatus.

### 2. Related Art

A three-dimensional object printing apparatus that performs printing on a surface of a three-dimensional workpiece by an ink jet method using a robot, for example, performs printing on a surface of a three-dimensional object by using a robot that holds a print head, as disclosed in JP-A-2014-111307.

In the three-dimensional object printing apparatus as described above, the operation or the error of the robot that holds the print head affects the accuracy of the print path, which is the path on which the print head moves, and the accuracy of the print path affects the print quality. However, it is a heavy burden for the user of the three-dimensional object printing apparatus to generate an appropriate print path in consideration of the operation or error of the robot that holds the print head.

### SUMMARY

According to an aspect of the present disclosure, there is provided a three-dimensional object printing system including: a three-dimensional object printing apparatus including a print head that discharges a liquid toward a three-dimensional workpiece, and a robot that holds the print head; and a server communicatively connected to the three-dimensional object printing apparatus, in which the server acquires workpiece information regarding the workpiece, and generates, based on the workpiece information, a print path that is a path on which the print head moves with respect to the workpiece.

According to another aspect of the present disclosure, there is provided a control method of a three-dimensional object printing system including a three-dimensional object printing apparatus and a server, the three-dimensional object printing apparatus including a print head that discharges a liquid toward a three-dimensional workpiece, and a robot that holds the print head, and the server being communicatively connected to the three-dimensional object printing apparatus, the method including: a workpiece information acquiring step of acquiring workpiece information regarding the workpiece; and a path generating step of generating, based on the workpiece information, a print path that is a path on which the print head moves with respect to the workpiece.

According to still another aspect of the present disclosure, there is provided a three-dimensional object printing apparatus including: a print head that discharges a liquid toward a three-dimensional workpiece; a robot that holds the print head; and a control portion that is communicatively connected to a server, in which the control portion transmits workpiece information regarding the workpiece to the server, and receives, from the server, a print path that is a path on which the print head moves with respect to the workpiece.

### BRIEF DESCRIPTION OF THE DRAWINGS

FIG. 1 is a schematic diagram illustrating a configuration example of a three-dimensional object printing system according to a first embodiment.

FIG. 2 is a perspective view illustrating an overview of the three-dimensional object printing apparatus according to the first embodiment.

FIG. 3 is a block diagram illustrating an electrical configuration of the three-dimensional object printing apparatus according to the first embodiment.

FIG. 4 is a schematic diagram illustrating a configuration example of a server used in a three-dimensional object printing system according to the first embodiment.

FIG. 5 is a flowchart illustrating a control method of a three-dimensional object printing system according to the first embodiment.

FIG. 6 is a diagram for describing acquisition of workpiece information and image information.

FIG. 7 is a schematic diagram illustrating a configuration example of a server used in a three-dimensional object printing system according to a second embodiment.

FIG. 8 is a flowchart illustrating generation of error information in the second embodiment.

FIG. 9 is a diagram for describing error information for each virtual path.

FIG. 10 is a flowchart illustrating correction of a print path in the second embodiment.

### DESCRIPTION OF EMBODIMENTS

Hereinafter, preferred embodiments according to the present disclosure will be described with reference to the attached drawings. In the drawings, the dimensions and scale of each portion may differ from the actual ones as appropriate, and some parts are schematically illustrated for ease of understanding. Further, the scope of the present disclosure is not limited to these aspects unless otherwise stated to limit the present disclosure in the following description.

### 1. FIRST EMBODIMENT

### 1-1. Overview of Three-Dimensional Object Printing System

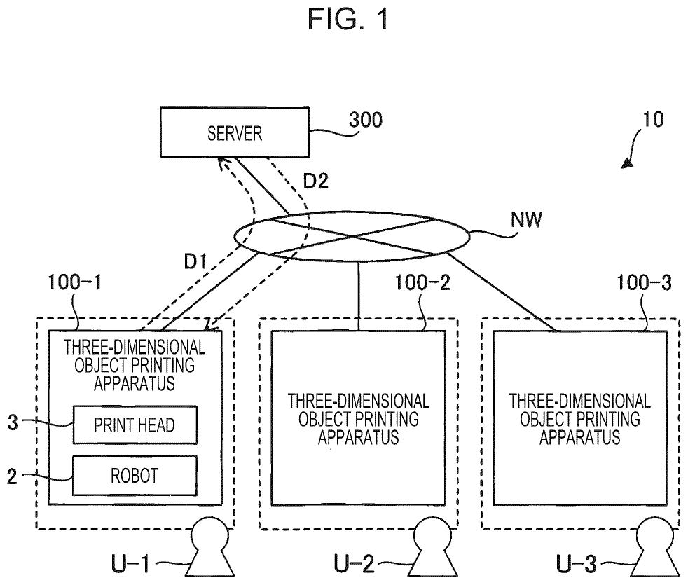

FIG. 1 is a schematic diagram illustrating a configuration example of a three-dimensional object printing system 10 according to a first embodiment. The three-dimensional object printing system 10 includes three-dimensional object printing apparatuses 100-1 to 100-3 and a server 300. Hereinafter, each of the three-dimensional object printing apparatuses 100-1 to 100-3 may be referred to as a three-dimensional object printing apparatus 100 without distinction. In the example illustrated in FIG. 1, the number of three-dimensional object printing apparatuses 100 included in the three-dimensional object printing system 10 is three, but the number is not limited thereto, and may be one, two, or four or more.

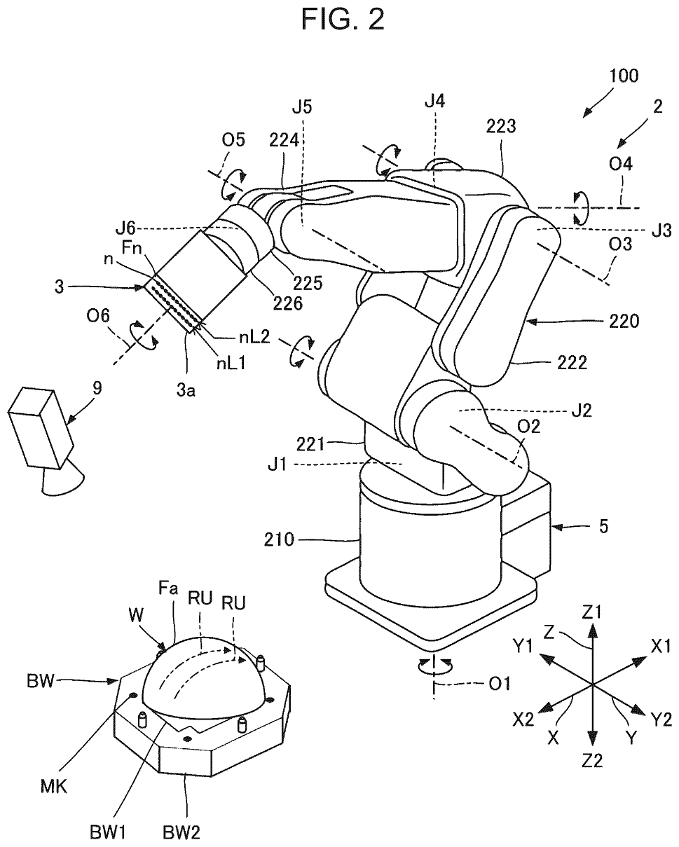

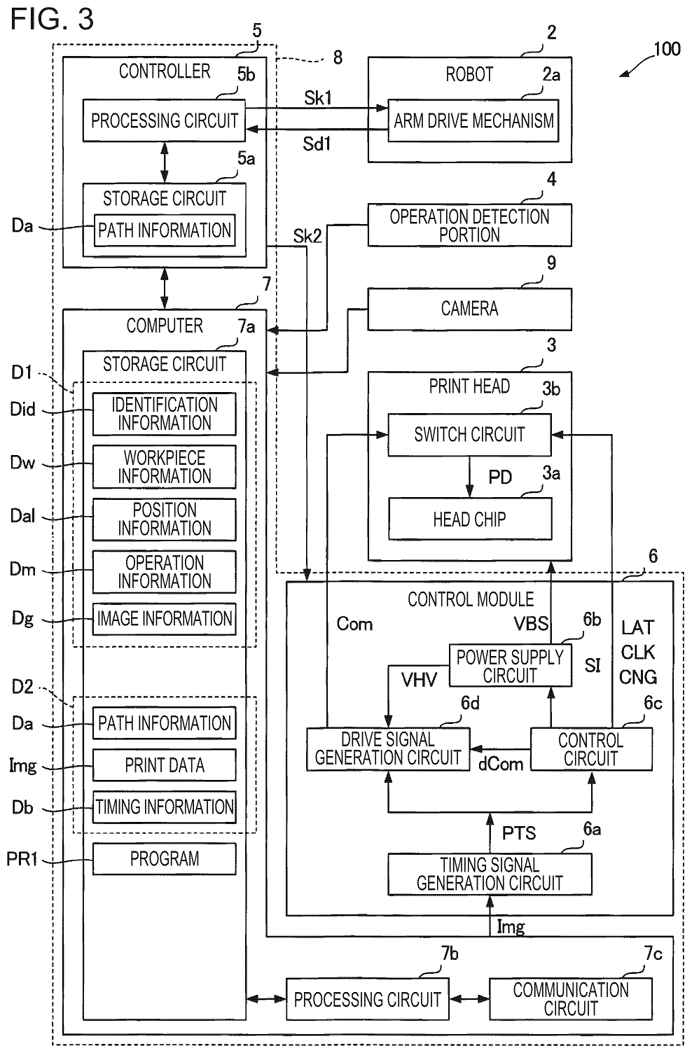

The three-dimensional object printing apparatus 100 is an apparatus that performs printing on a surface of a three-dimensional workpiece W by an ink jet method. The three-dimensional object printing apparatus 100 includes a print head 3 which is an ink jet head that discharges a liquid toward the three-dimensional workpiece W, and a robot 2 that holds the print head 3. The robot 2 changes the position and the posture of the print head 3. Details of the configuration of the three-dimensional object printing apparatus 100 will be described later with reference to FIGS. 2 and 3. The configurations of the plurality of three-dimensional object printing apparatuses 100 included in the three-dimensional object printing system 10 may be the same as each other or may be different from each other.

The three-dimensional object printing apparatus 100-1 is used by a user U-1. The three-dimensional object printing apparatus 100-2 is used by a user U-2. The three-dimensional object printing apparatus 100-3 is used by a user U-3. In the following, without distinguishing each of the users U-1 to U-3, the users may be referred to as a user U. The users U of the plurality of three-dimensional object printing apparatuses 100 included in the three-dimensional object printing system 10 may be the same as or different from each other.

Here, the robot 2 is manufactured by a robot manufacturer who is different from the user U. On the other hand, the print head 3 is manufactured by a head manufacturer who is different from the user U. In the present embodiment, the head manufacturer is the same as the robot manufacturer. The head manufacturer and the robot manufacturer may be different from each other.

The three-dimensional object printing apparatus 100 is communicatively connected to the server 300 via a communication network NW including the Internet, and has a function of outputting information D1 to the server 300, a function of receiving information D2 from the server 300, and a function of executing a printing operation based on the information D2. The information D1 includes information necessary to generate the movement path of the print head 3 by the robot 2 and the discharge timing of the print head 3, which will be described in detail later. The information D2 includes information regarding the movement path of the print head 3 by the robot 2 and the discharge timing of the print head 3, which will be described in detail later. The plurality of pieces of information included in the information D1 are output from the three-dimensional object printing apparatus 100 at different timings as appropriate, as will be described later. In addition, the plurality of pieces of information included in the information D2 are input to the three-dimensional object printing apparatus 100 at different timings as appropriate, as will be described later.

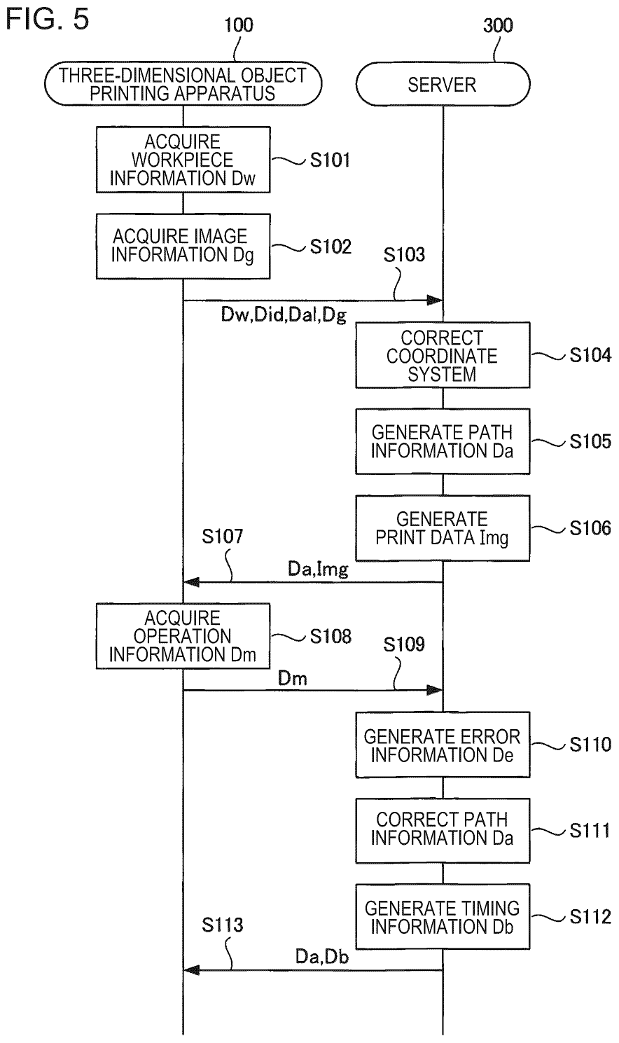

The server 300 is a computer that functions as a cloud server, and is communicatively connected to the three-dimensional object printing apparatus 100. The server 300 has a function of receiving the information D1 from the three-dimensional object printing apparatus 100 and a function of outputting the information D2 according to the information D1 to the three-dimensional object printing apparatus 100. The configuration of the server 300 will be described in detail later with reference to FIG. 5. The plurality of pieces of information included in the information D1 are input to the server 300 at different timings as appropriate, as will be described later. In addition, the plurality of pieces of information included in the information D2 are output from the server 300 at different timings as appropriate, as will be described later.

The server 300 may be owned by the robot manufacturer itself, or may be owned by a third party other than the robot manufacturer, as long as the robot manufacturer is able to provide the services required by the user U. Here, the user U does not own the server 300, but the three-dimensional object printing apparatus 100 owned by the user U is communicatively connected to the server 300 via the communication network NW. When the server 300 is owned by a third party, a processing apparatus (not shown) owned by the robot manufacturer itself is communicatively connected to the server 300 through the communication network NW. The processing apparatus is maintained and managed by a head manufacturer.

### 1-2. Three-Dimensional Object Printing Apparatus

FIG. 2 is a perspective view illustrating an overview of the three-dimensional object printing apparatus 100 according to the first embodiment. The three-dimensional object printing apparatus 100 is an apparatus that performs printing on a surface of a three-dimensional workpiece W by an ink jet method.

In the following, for convenience of description, an X axis, a Y axis, and a Z axis that intersect with each other are appropriately used. In addition, hereinafter, one direction along the X axis is an X1 direction, and a direction opposite to the X1 direction is an X2 direction. Similarly, the directions opposite to each other along the Y axis are a Y1 direction and a Y2 direction. In addition, the directions opposite to each other along the Z axis are a Z1 direction and a Z2 direction.

Here, the X axis, the Y axis, and the Z axis correspond to the coordinate axes of the world coordinate system set in the space where the robot 2 to be described later is installed. Typically, the Z axis is a vertical axis, and the Z2 direction corresponds to a downward direction in the vertical direction. A base coordinate system based on the position of a base portion 210 to be described later of the robot 2 is associated with the world coordinate system by calibration. In the following, for convenience, a case where the operation of the robot 2 is controlled by using the world coordinate system as the robot coordinate system is exemplified.

The Z axis does not have to be a vertical axis. Further, the X axis, the Y axis, and the Z axis are typically orthogonal to each other, but the present disclosure is not limited thereto, and the X axis, the Y axis, and the Z axis may not be orthogonal to each other. For example, the X axis, Y axis, and Z axis may intersect with each other at an angle within the range of 80° or more and 100° or less.

In the example illustrated in FIG. 2, the workpiece W is a hemisphere having a surface Fa to be printed, and is mounted on a mount portion BW. An aspect such as a shape or a size of the workpiece W is not limited to the example illustrated in FIG. 2, and is selected in any desired manner.

The mount portion BW is a base that supports the workpiece W. When the three-dimensional shape of the workpiece W is measured by a camera 9, the mount portion BW is placed at any position and posture within the image capturing range of the camera 9. On the other hand, when the workpiece W is printed by the three-dimensional object printing apparatus 100, at least a part of the mount portion BW is placed at a predetermined position associated with the world coordinate system.

In the present embodiment, the mount portion BW has a first tray portion BW1 and a second tray portion BW2. The first tray portion BW1 and the second tray portion BW2 are detachably fixed in a state of being positioned with respect to each other. Here, the first tray portion BW1 is provided with a fixing portion (not illustrated) for fixing the workpiece W. When the three-dimensional shape of the workpiece W is measured by the camera 9, the workpiece W is supported by the fixing portion in a state where the first tray portion BW1 is attached to the second tray portion BW2. On the other hand, when the workpiece W is printed by the three-dimensional object printing apparatus 100, the first tray portion BW1 is placed at a predetermined position associated with the world coordinate system in a state where the first tray portion BW1 is removed from the second tray portion BW2, and the workpiece W is supported by the fixing portion. The second tray portion BW2 is provided with a marker MK. The marker MK is captured together with the workpiece W by the camera 9, and is used to grasp the position and the posture of the workpiece W with respect to the mount portion BW based on the capturing result.

As illustrated in FIG. 2, the three-dimensional object printing apparatus 100 includes the robot 2, the print head 3, a controller 5, and the camera 9. Hereinafter, first, the robot 2, the print head 3, the controller 5, and the camera 9 will be briefly described in order with reference to FIG. 2.

The robot 2 is a robot that changes the position and the posture of the print head 3 in the world coordinate system. That is, the robot 2 moves the print head 3 while changing the posture of the print head 3 with respect to the three-dimensional workpiece W. During printing of the three-dimensional object printing apparatus 100, the robot 2 moves the print head 3 along a print path RU along the surface Fa of the workpiece W. The print path RU is set by path information Da to be described later. In FIG. 2, an aspect in which the print path RU is divided into a plurality of paths is illustrated, but the present disclosure is not limited to this aspect, and the print path RU may be a path consisting of one path.

In the example illustrated in FIG. 2, the robot 2 is a so-called six-axis vertical articulated robot. As illustrated in FIG. 2, the robot 2 has a base portion 210 and an arm 220.

The base portion 210 is a base that supports the arm 220. In the example illustrated in FIG. 2, the base portion 210 is fixed to a floor surface facing the Z1 direction or an installation surface such as a base by screwing or the like. The installation surface to which the base portion 210 is fixed is not limited to the example illustrated in FIG. 2, and may be, for example, a surface of a wall, a ceiling, a movable carriage, or the like.

The arm 220 is coupled to the base portion 210 and changes the position and the posture of the print head 3 with respect to the workpiece W. In the example illustrated in FIG. 2, the arm 220 is a six-axis robot arm that changes the position and the posture of the print head 3 with respect to the base portion 210 in three dimensions. Specifically, the arm 220 has arms 221, 222, 223, 224, 225, and 226, which are coupled in this order.

The arm 221 is rotatably coupled to the base portion 210 around a rotation axis O1 via a joint J1. The arm 222 is rotatably coupled to the arm 221 around a rotation axis O2 via a joint J2. The arm 223 is rotatably coupled to the arm 222 around a rotation axis O3 via a joint J3. The arm 224 is rotatably coupled to the arm 223 around a rotation axis O4 via a joint J4. The arm 225 is rotatably coupled to the arm 224 around a rotation axis O5 via a joint J5. The arm 226 is rotatably coupled to the arm 225 around a rotation axis O6 via a joint J6.

Each of the joints J1 to J6 is a mechanism for rotatably coupling one of two adjacent members of the base portion 210 and the arms 221 to 226 to the other. In the following, each of the joints J1 to J6 may be referred to as a “joint J”.

Although not illustrated in FIG. 2, each of the joints J1 to J6 is provided with a drive mechanism that rotates the corresponding joint J. An assembly of the drive mechanisms of the joints J1 to J6 corresponds to an arm drive mechanism 2a illustrated in FIG. 3 to be described later.

The rotation axis O1 is an axis perpendicular to the installation surface (not illustrated) to which the base portion 210 is fixed. The rotation axis O2 is an axis perpendicular to the rotation axis O1. The rotation axis O3 is an axis parallel to the rotation axis O2. The rotation axis O4 is an axis perpendicular to the rotation axis O3. The rotation axis O5 is an axis perpendicular to the rotation axis O4. The rotation axis O6 is an axis perpendicular to the rotation axis O5.

Regarding these rotation axes, “perpendicular” includes not only the case where the angle formed by the two rotation axes is exactly 90°, and but also the case where the angle formed by the two rotation axes is shifted within a range of approximately 90°±5°. Similarly, “parallel” includes not only the case where the two rotation axes are exactly parallel, but also the case where one of the two rotation axes is inclined within a range of approximately +5° with respect to the other. In addition, the directions of these rotation axes are not limited to the example illustrated in FIG. 2.

The print head 3 is mounted on the arm 226, which is the distal end of the arm 220 of the robot 2 described above, as an end effector. In the example illustrated in FIG. 2, the print head 3 is fixed to the arm 226 by screwing or the like.

The print head 3 is an assembly having a head chip 3a that discharges ink, which is an example of a “liquid”, toward the workpiece W. The head chip 3a has a plurality of nozzles n that are open to a discharge surface Fn, and although not illustrated, the head chip 3a is provided with a piezoelectric element that is a drive element and a cavity that accommodates ink for each nozzle n.

As the drive element for discharging the ink from the nozzle, a heater that heats the ink in the cavity may be used, instead of the piezoelectric element.

In the example illustrated in FIG. 2, the plurality of nozzles n included in the head chip 3a are divided into a nozzle row nL1 and a nozzle row nL2. Each of the nozzle row nL1 and the nozzle row nL2 is a set of a plurality of nozzles n arranged in the width direction of the head chip 3a. Here, the head chip 3a is configured such that the type of ink used for the nozzle row nL1 can be made different from the type of ink used for the nozzle row nL2. The plurality of nozzles n included in the head chip 3a may be divided into three or more nozzle rows.

The ink is not particularly limited, and includes, for example, an aqueous ink in which a coloring material such as a dye or a pigment is dissolved in an aqueous solvent, a curable ink using a curable resin such as an ultraviolet curable type, a solvent-based ink in which a coloring material such as a dye or a pigment is dissolved in an organic solvent, and the like. Among the inks, the curable ink is preferably used. The curable ink is not particularly limited, and may have, for example, any of a thermosetting type, a photocurable type, a radiation curable type, an electron beam curable type, and the like, and a photocurable type such as an ultraviolet curable type is preferable. The ink is not limited to the solution, and may be an ink in which a coloring material or the like is dispersed as a dispersant in a dispersion medium. Further, the ink is not limited to an ink containing a coloring material, and may be, for example, an ink containing conductive particles such as metal particles for forming wiring or the like as a dispersant, a clear ink, or a treatment liquid for surface treatment of the workpiece W.

In addition to the head chip 3a, the print head 3 may include, for example, a valve mechanism that opens and closes according to the pressure of the ink in the head chip 3a, or may include a light source that emits energy such as light, heat, an electron beam, or radiation for curing or solidifying the ink on the workpiece W. In addition, the number of head chips 3a included in the print head 3 is not limited to the example illustrated in FIG. 2, and may be two or more.

The camera 9 is a three-dimensional camera that measures a three-dimensional shape of a three-dimensional object to be measured. The camera 9 is supported by a support body (not illustrated) and captures an image of the workpiece W fixed to the mount portion BW together with the mount portion BW. The camera 9 may acquire three-dimensional shape data of the three-dimensional object to be measured, and is not particularly limited, and is various sensors also referred to as a three-dimensional sensor or a vision sensor.

Here, the camera 9 may be a sensor such as a passive sensor or an active sensor based on the principle of triangulation, or may be a sensor such as a focus utilization type or a time-of-flight method (TOF) based on the principle of coaxial measurement.

Although not illustrated, the camera 9 includes, for example, an image capturing optical system and an image capturing element. The image capturing optical system is an optical system including at least one image capturing lens, and may include various optical elements such as a prism, or may include a zoom lens, a focus lens, or the like. The image capturing element is, for example, a charge coupled device (CCD) image sensor or a complementary MOS (CMOS) image sensor. The camera 9 may have a light source including a light emitting element such as a light emitting diode (LED) that emits light toward the image capturing range. In addition, when the camera 9 itself has an image processing function, the CAD data of the object to be captured can be output to a computer 7.

Here, a three-axis image capturing coordinate system is set for the camera 9. The image capturing coordinate system may be associated with the world coordinate system by calibration. The camera 9 generates shape data indicating a three-dimensional shape of the object to be captured in the image capturing coordinate system.

The installation form of the camera 9 may be any as long as the mount portion BW in a state of supporting the workpiece W can be captured, and for example, the camera 9 may be supported by the robot 2, or may be supported by a moving mechanism such as a multi-joint robot or a conveyor different from the robot 2. In addition, the capturing by the camera 9 may be performed by a person.

The controller 5 is a robot controller that controls the driving of the robot 2. Hereinafter, an electrical configuration of the three-dimensional object printing apparatus 100 will be described with reference to FIG. 3, including a detailed description of the controller 5.

FIG. 3 is a block diagram illustrating an electrical configuration of the three-dimensional object printing apparatus 100 according to the first embodiment. In FIG. 3, among components of the three-dimensional object printing apparatus 100, electrical components are illustrated. As illustrated in FIG. 3, the three-dimensional object printing apparatus 100 includes an operation detection portion 4, a control module 6, and a computer 7, in addition to the components illustrated in FIG. 2 described above. The control module 6 is communicatively connected to the controller 5. The computer 7 is communicatively connected to the camera 9, the operation detection portion 4, the controller 5, and the control module 6. Here, a control portion 8 is configured with the controller 5, the control module 6, and the computer 7. The control portion 8 controls the operation of each of the robot 2 and the print head 3. Hereinafter, each portion of the control portion 8 will be described in order with reference to FIG. 3.

Noted that each of the electric components illustrated in FIG. 3 may be appropriately divided, and a part thereof may be included in another component or may be integrally configured with the other component. For example, a part of the entirety of the functions of the controller 5 or the control module 6 may be realized by the computer 7, or may be realized by another external apparatus such as a personal computer (PC) connected to the controller 5 via a network such as a local area network (LAN) or the Internet.

The operation detection portion 4 generates operation information Dm to be described later by detecting an operation of the robot 2. Specifically, the operation detection portion 4 outputs a signal corresponding to the displacement of the distal end of the arm 220 of the robot 2, that is, the displacement of the print head 3. For example, the operation detection portion 4 is an acceleration sensor attached to the distal end of the arm 220 or the print head 3. The operation detection portion 4 may use a signal Sd1 from the arm drive mechanism 2a to be described later, or may detect the displacement of the distal end of the arm 220 or the print head 3 by a camera such as the camera 9.

The controller 5 has a function of controlling the driving of the robot 2 and a function of generating a signal Sk2 for synchronizing the ink discharge operation of the print head 3 with the operation of the robot 2.

The controller 5 has a storage circuit 5a and a processing circuit 5b.

The storage circuit 5a stores various programs executed by the processing circuit 5b and various types data processed by the processing circuit 5b. The storage circuit 5a includes one or both semiconductor memories, for example, a volatile memory such as a random access memory (RAM); and a non-volatile memory such as a read only memory (ROM), an electrically erasable programmable read-only memory (EEPROM), or a programmable ROM (PROM). A part or the entirety of the storage circuit 5a may be included in the processing circuit 5b.

The path information Da is stored in the storage circuit 5a.

The path information Da is information indicating a print path which is a path on which the print head 3 moves with respect to the workpiece W. The path information Da is used to control the operation of the robot 2, and indicates the position and the posture of the print head 3 on the path on which the print head 3 is supposed to move when the printing operation is executed. The position and the posture of the print head 3 are defined with reference to a tool center point of the robot 2. The tool center point may be disposed at, for example, the center of the nozzle surface, which is the distal end surface of the head chip 3a, or may be at a position spaced apart from the head chip 3a in the ink discharge direction. The path information Da is represented by, for example, coordinate values in a coordinate system such as a workpiece coordinate system, a base coordinate system, or a world coordinate system. However, when the path information Da is represented by using the coordinate values of the workpiece coordinate system, the path information Da is used for controlling the operation of the robot 2 after conversion from the coordinate values of the workpiece coordinate system to the coordinate values of the base coordinate system or the world coordinate system. The path information Da is generated by the server 300 and is input to the controller 5 from the server 300 via the computer 7. The temporary path information Da may be generated by the computer 7.

The processing circuit 5b controls the operation of the arm drive mechanism 2a of the robot 2 based on the path information Da, and also generates the signal Sk2. The processing circuit 5b is, for example, a processor, such as one or more central processing units (CPU). The processing circuit 5b may include a programmable logic device such as a field-programmable gate array (FPGA) instead of the CPU or in addition to CPU.

Here, the arm drive mechanism 2a is an assembly of the drive mechanisms of the joints J1 to J6 described above, and includes a motor for driving the joint J of the robot 2 and an encoder for detecting the rotation angle of the joint J of the robot 2 for each joint J.

The processing circuit 5b performs inverse kinematics calculation, which is an arithmetic operation for converting the path information Da into an operating amount such as a rotation angle and a rotation speed of each joint J of the robot 2. Then, the processing circuit 5b outputs a control signal Sk1 based on an output Sd1 from each encoder of the arm drive mechanism 2a such that the operating amount such as the actual rotation angle and the rotation speed of each joint J becomes the above-described arithmetic operation result based on the path information Da. The control signal Sk1 is a signal for controlling the driving of the motor of the arm drive mechanism 2a. Here, the control signal Sk1 is corrected by the processing circuit 5b based on an output from a distance sensor (not illustrated), as needed. As described above, the processing circuit 5b performs the drive control of the robot 2 by the control signal Sk1 for the feedback control based on the path information Da and the output Sd1.

Further, the processing circuit 5b generates the signal Sk2, based on the output Sd1 from at least one of a plurality of encoders included in the arm drive mechanism 2a. For example, the processing circuit 5b generates, as a signal Sk2, a trigger signal including a pulse at a timing at which the output Sd1 from one of the plurality of encoders becomes a predetermined value.

The control module 6 is a circuit that controls the ink discharge operation of the print head 3 based on the signal Sk2 output from the controller 5 and print data Img and timing information Db from the computer 7. The control module 6 includes a timing signal generation circuit 6a, a power supply circuit 6b, a control circuit 6c, and a drive signal generation circuit 6d.

The timing signal generation circuit 6a generates a timing signal PTS based on the signal Sk2 and the timing information Db. The timing signal generation circuit 6a is configured with, for example, a timer that starts the generation of the timing signal PTS when the signal Sk2 is detected, and adjusts the timing interval defined by the timing signal PTS based on the timing information Db.

The power supply circuit 6b receives power from a commercial power source (not illustrated) and generates various predetermined potentials. Each of the generated various potentials is appropriately supplied to each portion of the control module 6 and the print head 3. For example, the power supply circuit 6b generates a power supply potential VHV and an offset potential VBS. The offset potential VBS is supplied to the print head 3. Further, the power supply potential VHV is supplied to the drive signal generation circuit 6d.

The control circuit 6c generates a control signal SI, a waveform designation signal dCom, a latch signal LAT, a clock signal CLK, and a change signal CNG, based on the timing signal PTS. These signals are synchronized with the timing signal PTS. Among these signals, the waveform designation signal dCom is input to the drive signal generation circuit 6d, and the other signals are input to a switch circuit 3b of the print head 3.

The control signal SI is a digital signal for designating the operation state of the drive element included in the head chip 3a of the print head 3.

Specifically, the control signal SI is a signal for designating whether or not to supply a drive signal Com to be described later to the drive element based on the print data Img. By this designation, it is designated, for example, whether or not to discharge ink from the nozzle corresponding to the drive element, or the amount of ink discharged from the nozzle is designated. The waveform designation signal dCom is a digital signal for defining the waveform of the drive signal Com. The latch signal LAT and the change signal CNG are signals for defining a discharge timing of the ink from the nozzle, in combination with the control signal SI, by defining a drive timing of the drive element. The clock signal CLK is a reference clock signal synchronized with the timing signal PTS.

The above control circuit 6c includes, for example, one or more processors such as a CPU. The control circuit 6c may include a programmable logic device such as an FPGA instead of the CPU or in addition to the CPU.

The drive signal generation circuit 6d is a circuit that generates the drive signal Com for driving each drive element of the head chip 3a of the print head 3. Specifically, the drive signal generation circuit 6d has, for example, a DA conversion circuit and an amplification circuit. In the drive signal generation circuit 6d, the DA conversion circuit converts the waveform designation signal dCom from the control circuit 6c from a digital signal into an analog signal, and the amplification circuit generates the drive signal Com by amplifying the analog signal using the power supply potential VHV from the power supply circuit 6b. Here, among the waveforms included in the drive signal Com, the waveform signal actually supplied to the drive element is a drive pulse PD. The drive pulse PD is supplied to the drive element from the drive signal generation circuit 6d via the switch circuit 3b of the print head 3.

Here, the switch circuit 3b is a circuit including a switching element that switches whether or not to supply at least a part of the waveform included in the drive signal Com as the drive pulse PD based on the control signal SI.

The computer 7 has a function of supplying information such as the path information Da to the controller 5 and a function of supplying information such as the print data Img and the timing information Db to the control module 6. In addition, the computer 7 has a function of outputting the information D1 to the server 300 and a function of receiving the information D2 from the server 300.

The computer 7 includes a storage circuit 7a, a processing circuit 7b, and a communication circuit 7c. The computer 7 may further include an input device such as a keyboard or a mouse that receives an operation from the user, or may further include a display device such as a liquid crystal panel that displays information necessary for generating the path information Da.

The storage circuit 7a stores various programs to be executed by the processing circuit 7b and various types of data to be processed by the processing circuit 7b. The storage circuit 7a includes one or both semiconductor memories, for example, a volatile memory such as a RAM; and a non-volatile memory such as a ROM, an EEPROM, or a PROM. A part or all of the storage circuit 7a may be included in the processing circuit 7b.

The storage circuit 7a stores a program PR1, the information D1, and the information D2.

The program PR1 is a program for executing processing necessary for outputting the information D1 to the server 300 and receiving the information D2 from the server 300.

The information D1 includes identification information Did, workpiece information Dw, position information Dal, operation information Dm, and image information Dg as information output to the server 300.

The identification information Did is information for specifying the types of the robot 2 and the print head 3 used in the three-dimensional object printing apparatus 100, and indicates, for example, a unique number such as a serial number which is unique to the three-dimensional object printing apparatus 100. The identification information Did may include information indicating a unique number such as a serial number which is unique to the robot 2 and information indicating a unique number such as a serial number which is unique to the print head 3. The identification information Did, as described above, is stored in advance in the storage circuit 7a at the time of manufacturing or shipping the three-dimensional object printing apparatus 100.

The workpiece information Dw is information regarding the workpiece W, and indicates, for example, at least a shape, a material, an orientation, and a position of the workpiece W. Specifically, the workpiece information Dw includes, for example, three-dimensional data such as a standard triangulated language (STL) format or a 3D manufacturing format (3MF) format representing the shape of the workpiece W by a plurality of polygons, and information indicating the material, orientation, and position of the workpiece W. The 3MF format data is shape data with data texture, in which the coordinate on the polygon data indicating the three-dimensional shape and the color information indicating the color corresponding to the coordinate are integrated. Therefore, when the workpiece information Dw is the data in the 3MF format, the workpiece information Dw may include the image information Dg as color information in an integrated manner, or the region to be printed on the workpiece W indicated by the workpiece information Dw may be represented by the color information. The workpiece information Dw may be data generated by measuring the shape of the workpiece W by a three-dimensional camera such as the camera 9, or may be data obtained by performing conversion processing on computer-aided design (CAD) data indicating the three-dimensional shape of the workpiece W as necessary. The workpiece information Dw may be represented by using coordinate values of the workpiece coordinate system, or may be represented by point group data using coordinate values of the base coordinate system or the world coordinate system. Further, the workpiece information Dw may be represented by an equation or the like, and a format of the workpiece information Dw can be appropriately converted as needed.

The position information Dal is information regarding a positional relationship between the workpiece W and the mount portion BW on which the workpiece W is mounted. The position information Dal is, for example, information indicating an image obtained by capturing the marker MK of the mount portion BW together with the workpiece W by the camera 9. The position information Dal may be included in the workpiece information Dw.

The operation information Dm is information regarding the operation of the robot 2, and is acquired from the operation detection portion 4 during a period in which the robot 2 is operated based on the path information Da. Here, the operation information Dm includes one or both of the information detected by the operation detection portion 4 during the period in which the three-dimensional object printing apparatus 100 is performing printing and the information detected by the operation detection portion 4 during the period in which the three-dimensional object printing apparatus 100 is executing the preparatory operation. The preparatory operation is an operation of moving the print head 3 along the print path indicated by the path information Da by the robot 2 without discharging the liquid from the print head 3.

The image information Dg is information indicating an image to be printed on the workpiece W. The format of the image information Dg is not particularly limited, and is, for example, a bitmap format such as JPEG, or a vector format such as PostScript, Portable Document Format (PDF), and XML Paper Specification (XPS).

The information D2 includes the path information Da, the print data Img, and the timing information Db as the information input from the server 300.

The print data Img is information indicating an image to be printed on the workpiece W for each path of a print path indicated by the path information Da. Here, when it is necessary to divide the print image to be printed on the workpiece W into a plurality of paths and print the print image, the print data Img includes information indicating a plurality of divided images obtained by dividing the print image for each path. The print data Img is image data in a format that can be processed by the control module 6, and is obtained by the server 300 processing the image information Dg. The processing includes at least one of image processing such as color conversion processing, density correction processing, quantization processing, distribution processing, and raster image processor (RIP) processing.

In the present embodiment, the print data Img is represented by using the coordinate values in a second coordinate system to be described later, and includes information for correcting first coordinates to second coordinates to be described later. The print data Img may be represented by using coordinate values in a first coordinate system to be described later. In this case, the print data Img may not include information for correcting the first coordinate to be described later to the second coordinate.

The timing information Db is information indicating the discharge timing of the print head 3. The timing information Db is obtained based on the operation information Dm and head information Dh at the server 300. By adjusting the discharge timing indicated by the timing information Db, the error in the scanning direction of the robot 2 when the print head 3 is moved along the print path can be reduced.

The processing circuit 7b realizes each of the functions described above by executing a program such as the program PR1. The processing circuit 7b includes, for example, one or more processors such as a CPU. The processing circuit 7b may include a programmable logic device such as an FPGA instead of the CPU or in addition to the CPU.

The processing circuit 7b realizes various functions necessary for the output of the information D1 and the receiving of the information D2 by executing the program PR1. As described above, the control portion 8 transmits the workpiece information Dw to the server 300 and receives the print path indicated by the path information Da from the server 300.

As described above, the printing operation is performed by controlling the driving of the robot 2 based on the path information Da and controlling the driving of the print head 3 based on the print data Img, the timing information Db, and the signal Sk2. In the printing operation, the robot 2 changes the position and the posture of the head chip 3a based on the path information Da, and the head chip 3a discharges the ink from the print head 3 toward the workpiece W at an appropriate timing based on the print data Img, the timing information Db, and the signal Sk2. Thus, an image based on the print data Img is formed at the workpiece W.

### 1-3. Configuration of Server

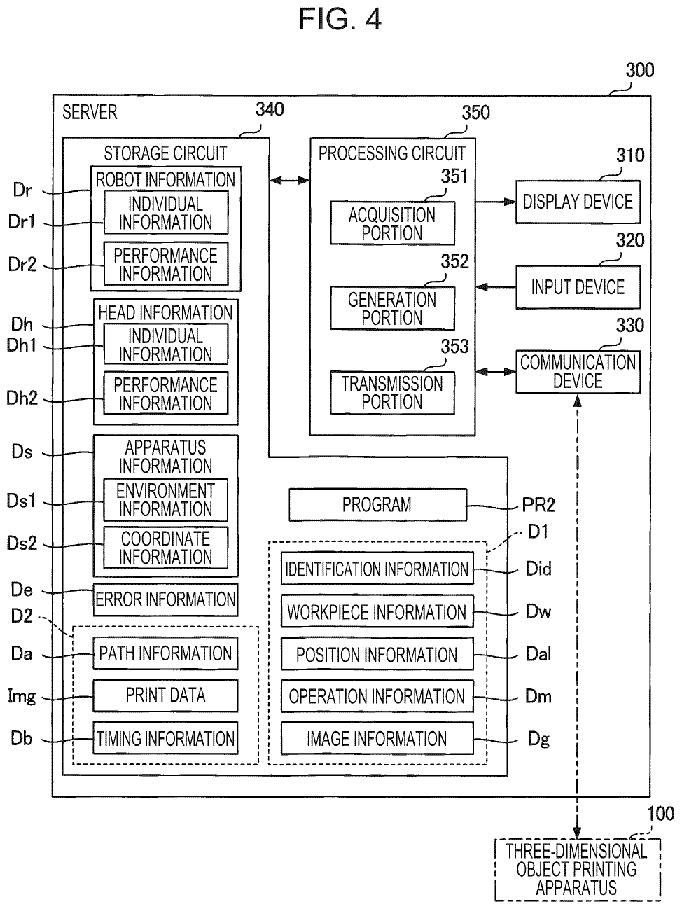

FIG. 4 is a schematic diagram illustrating a configuration example of the server 300 used in the three-dimensional object printing system 10 according to the first embodiment. As shown in FIG. 4, the server 300 includes a display device 310, an input device 320, a communication device 330, a storage circuit 340, and a processing circuit 350. The components are communicatively connected to each other. The storage circuit 340 is an example of a “storage portion”.

The display device 310 displays various images under the control of the processing circuit 350. Here, the display device 310 includes a display panel such as a liquid crystal display panel or an organic electro-luminescence (EL) display panel.

The input device 320 is a device that receives operations from the user. For example, the input device 320 includes a pointing device such as a touch pad, a touch panel or a mouse. Here, when the input device 320 includes a touch panel, the input device 320 may also serve as the display device 310. The input device 320 may be provided outside the server 300. Further, the input device 320 may include other input devices such as a keyboard.

The communication device 330 is a circuit configured to communicate with the three-dimensional object printing apparatus 100. For example, the communication device 330 is a communication circuit having an interface such as a wireless or wired LAN or USB. The communication device 330 receives the information D1 or transmits the information D2 by communicating with the three-dimensional object printing apparatus 100. The communication device 330 may be integrated with the processing circuit 350.

The storage circuit 340 is a device that stores various programs executed by the processing circuit 350 and various types of data processed by the processing circuit 350. The storage circuit 340 has, for example, a hard disk drive or a semiconductor memory. A part or the entirety of the storage circuit 340 may be provided in a storage device, a computer, or another device external to the server 300.

The storage circuit 340 of the present embodiment stores a program PR2, the information D1, the information D2, robot information Dr, the head information Dh, apparatus information Ds, and error information De.

The program PR2 is a program for executing processing necessary for receiving the information D1 from the three-dimensional object printing apparatus 100 and outputting the information D2 to the three-dimensional object printing apparatus 100.

The robot information Dr is information regarding the robot 2. The robot information Dr includes individual information Dr1 and performance information Dr2. The individual information Dr1 is information for identifying the robot 2 and is associated with the identification information Did. As a result, the robot information Dr can be specified based on the identification information Did. The performance information Dr2 is information regarding the performance of the robot 2, and includes, for example, information indicating a movable range, an extension amount, a movement/deceleration speed, and the like of the robot 2. The robot information Dr may include, for example, the operation information Dm in addition to the individual information Dr1 and the performance information Dr2, and may include information indicating the change over time of the characteristics of the robot 2.

The head information Dh is information regarding the print head 3. The head information Dh includes individual information Dh1 and performance information Dh2. The individual information Dh1 is information for identifying the print head 3 and is associated with the identification information Did. As a result, the head information Dh can be specified based on the identification information Did. The performance information Dh2 is information regarding the performance of the print head 3, and includes, for example, information indicating the nozzle row width, the droplet amount, and the like of the print head 3. The head information Dh may include, for example, information indicating the size or length of the print head 3 in addition to the individual information Dh1 and the performance information Dh2, or may include information indicating the type of ink used for the print head 3.

The apparatus information Ds is information regarding a setting or a usage state of the three-dimensional object printing apparatus 100. The apparatus information Ds includes environment information Ds1 and coordinate information Ds2. The environment information Ds1 is information regarding the environment in which the robot 2 is installed, and includes, for example, information indicating temperature, humidity, an attachment direction of the robot 2, presence or absence of an obstacle, and the like as information regarding an element that may affect the characteristics of the robot 2 or the print head 3. The coordinate information Ds2 is information indicating a standard coordinate system which is a coordinate system of the three-dimensional object printing apparatus 100. The standard coordinate system is, for example, the world coordinate system described above. As described above, the server 300 stores the standard coordinate system, which is the coordinate system of the three-dimensional object printing apparatus 100. The apparatus information Ds is associated with the identification information Did and is specified based on the identification information Did.

The error information De is information regarding an error in the operation of the robot 2. The error information De of the present embodiment indicates the difference between the position and the posture of the print head 3 indicated by the operation information Dm and the position and the posture of the print head 3 indicated by the path information Da.

The processing circuit 350 is a device having a function of controlling each portion of the server 300 and a function of processing various data. The processing circuit 350 has, for example, a processor such as a central processing unit (CPU). The processing circuit 350 may be configured by a single processor or may be configured by a plurality of processors. In addition, a part or the entirety of the functions of the processing circuit 350 may be implemented by hardware such as a digital signal processor (DSP), an application specific integrated circuit (ASIC), a programmable logic device (PLD), a field programmable gate array (FPGA).

The processing circuit 350 functions as an acquisition portion 351, a generation portion 352, and a transmission portion 353 by reading the program PR2 from the storage circuit 340 and executing the program PR2.

The acquisition portion 351 executes processing for acquiring the information D1, the robot information Dr, the head information Dh, and the apparatus information Ds.

Specifically, the acquisition portion 351 acquires the information D1 from the three-dimensional object printing apparatus 100 and stores the acquired information D1 in the storage circuit 340. In addition, the acquisition portion 351 acquires the robot information Dr, the head information Dh, and the apparatus information Ds by any method, and stores the acquired information in the storage circuit 340.

Here, the acquisition portion 351 may acquire information in which the image information Dg and the workpiece information Dw are integrated. In this case, for example, the image information Dg is included in the information as color information regarding the color of the workpiece W.

Further, the operation information Dm included in the information D1 is acquired from the operation detection portion 4 during the period in which the robot 2 is operated based on the path information Da. The acquisition may be performed during the execution of the printing operation of discharging the ink from the print head 3, or may be performed during the execution of the preparatory operation of not discharging the ink from the print head 3. That is, the acquisition of the operation information Dm by the acquisition portion 351 may be performed during a period in which the three-dimensional object printing apparatus 100 performs printing, or may be performed during a period in which a preparatory operation of moving the print head 3 along the print path indicated by the path information Da is executed without discharging the liquid from the print head 3.

The generation portion 352 generates the information D2 based on the information D1, the robot information Dr, the head information Dh, and the apparatus information Ds.

Specifically, the generation portion 352 generates the print path indicated by the path information Da based on the workpiece information Dw. For this generation, the image information Dg is used as necessary. As a result, for example, the number of print paths can be set in consideration of the position and the size of the print region with respect to the workpiece W.

Here, the generation portion 352 corrects the coordinate system of the workpiece W mounted on the mount portion BW based on the standard coordinate system indicated by the position information Dal and the coordinate information Ds2. The position, size, and shape of each marker MK of the above-described mount portion BW are known and are represented as fixed values of the first coordinate system associated with the mount portion BW. Further, since the positional relationship between each marker MK and the workpiece W is fixed, the position and the posture of the workpiece W with respect to the mount portion BW can be represented by the first coordinate system. The correction is performed by converting the position information Dal from the first coordinate system to the second coordinate system which is the standard coordinate system. As a result, information representing the positional relationship between the workpiece W and the mount portion BW on which the workpiece W is mounted by the standard coordinate system is obtained.

Then, after the correction of the above-described coordinate system, the generation portion 352 generates the path information Da by using the robot information Dr and the apparatus information Ds specified by the identification information Did based on the workpiece information Dw in the second coordinate system which is the corrected coordinate system. The method of generating the path information Da is not particularly limited, and for example, the method described in JP-A-2023-31611 or US 2023/0064877 is used. The generation portion 352 may generate the path information Da represented by the second coordinate system by using the robot information Dr and the apparatus information Ds specified by the identification information Did based on the workpiece information Dw in the second coordinate system, and then convert the path information Da into the path information Da represented by the first coordinate system. In this case, the correction of the above-described coordinate system may not be performed.

Further, the generation portion 352 corrects the print path indicated by the path information Da based on the robot information Dr and the operation information Dm. As a result of the correction, mainly, the meandering of the print head 3 with respect to the print path is reduced. Here, the generation portion 352 generates the error information De by calculating the change over time of the operation of the robot 2 based on the operation information Dm, and corrects the print path indicated by the path information Da based on the change over time indicated by the error information De. The change over time corresponds to a change over time of a difference between the position and the posture of the print head 3 indicated by the operation information Dm and the position and the posture of the print head 3 indicated by the path information Da. Further, the generation portion 352 corrects the print path indicated by the path information Da based on the result simulated using the environment information Ds1. For example, the generation portion 352 corrects the print path Da such that the robot 2 or the print head 3 do not come into contact with an obstacle based on the result of the simulation in which the robot 2 is operated on a virtual space that mimics the environment where the robot 2 is installed using the environment information Ds1. The path information Da indicating the corrected print path generated as described above is stored in the storage circuit 340.

Further, the generation portion 352 generates the timing information Db by correcting the discharge timing of the print head 3 based on the operation information Dm. As a result of the correction, mainly, the deterioration of the image quality due to the speed unevenness in the main scanning direction of the print head 3 is reduced. In the present embodiment, the generation portion 352 corrects the discharge timing indicated by the timing information Db based on the operation information Dm and the head information Dh. The generated timing information Db as described above is stored in the storage circuit 340.

Further, the generation portion 352 generates the print data Img based on the corrected path information Da and the image information Dg. Here, when it is necessary to divide the print image to be printed on the workpiece W into a plurality of paths and print the print image, the generation portion 352 creates a divided image obtained by dividing the print image to be printed on the workpiece W based on the workpiece information Dw and the print path indicated by the corrected path information Da. As a result, the print data Img including the information indicating the plurality of divided images is obtained. The print data Img generated as described above is stored in the storage circuit 340.

The transmission portion 353 performs processing of transmitting various information included in the information D2 to the three-dimensional object printing apparatus 100 at an appropriate timing.

As described above, the server 300 acquires the workpiece information Dw regarding the workpiece W, and generates the print path indicated by the path information Da based on the workpiece information Dw. As a result, the burden on the user of the three-dimensional object printing apparatus 100 can be reduced. Further, since the server 300 is communicatively connected to the three-dimensional object printing apparatus 100 as described above, an appropriate print path can be applied from the server 300 to the three-dimensional object printing apparatus 100 in a timely manner. As a result, the print quality on the three-dimensional workpiece W can be improved.

### 1-4. Processing of Three-Dimensional Object Printing System

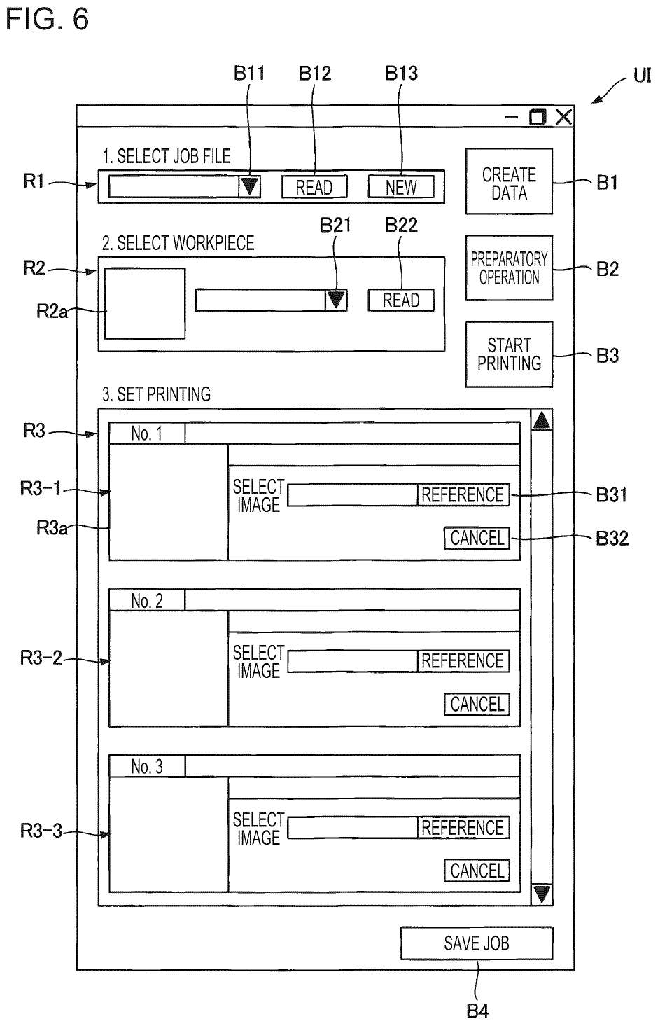

FIG. 5 is a flowchart illustrating a control method of the three-dimensional object printing system 10 according to the first embodiment. In the three-dimensional object printing system 10, first, as illustrated in FIG. 6, the three-dimensional object printing apparatus 100 acquires the workpiece information Dw in step S101, which is an example of the “workpiece information acquiring step”. In step S102, the three-dimensional object printing apparatus 100 acquires the image information Dg. Details of the acquisition of the workpiece information Dw and the image information Dg will be described later with reference to FIG. 6.

Thereafter, in step S103, the three-dimensional object printing apparatus 100 transmits the identification information Did, the workpiece information Dw, the position information Dal, and the image information Dg to the server 300. As a result, the acquisition portion 351 of the server 300 acquires the identification information Did, the workpiece information Dw, the position information Dal, and the image information Dg. The acquisition timings of the identification information Did, the workpiece information Dw, the position information Dal, and the image information Dg by the acquisition portion 351 may be different from each other. In addition, the acquisition timing of the image information Dg by the acquisition portion 351 may be earlier than step S106 or may be later than step S103.

After that, in step S104, the server 300 corrects the coordinate system of the workpiece W mounted on the mount portion BW based on the position information Dal and the standard coordinate system. The correction is performed by the generation portion 352 as described above.

Next, in step S105, which is an example of the “path generating step”, the server 300 generates the path information Da based on the workpiece information Dw, the robot information Dr, and the apparatus information Ds. This generation is performed by the generation portion 352 as described above.

Next, in step S106, the server 300 generates the print data Img. This generation is performed by the generation portion 352 as described above. The generation of the print data Img may be performed after the acquisition timing of the image information Dg by the acquisition portion 351, and may be performed before step S104 or step S105. In addition, when printing is not performed in step S108, the generation of the print data Img may be performed after step S107.

Next, in step S107, the server 300 transmits the path information Da and the print data Img to the three-dimensional object printing apparatus 100. The transmission is performed by the transmission portion 353 as described above. As a result, the three-dimensional object printing apparatus 100 acquires the path information Da and the print data Img. When printing is not performed in step S108, the transmission of the print data Img may be performed after step S106.

Thereafter, in step S108, the three-dimensional object printing apparatus 100 acquires the operation information Dm. This acquisition is performed by the acquisition portion 351 as described above.

Then, in step S109, the three-dimensional object printing apparatus 100 transmits the operation information Dm to the server 300. The transmission is performed by the transmission portion 353 as described above, and thus the acquisition portion 351 of the server 300 acquires the operation information Dm.

Thereafter, in step S110, the server 300 generates the error information De based on the operation information Dm. This generation is performed by the generation portion 352 as described above.

Next, in step S111, the server 300 corrects the path information Da based on the error information De. The correction is performed by the generation portion 352 as described above.

Next, in step S112, the server 300 generates the timing information Db based on the operation information Dm and the head information Dh. This generation is performed by the generation portion 352 as described above.

Thereafter, in step S113, the server 300 transmits the path information Da and the timing information Db to the three-dimensional object printing apparatus 100. The transmission is performed by the transmission portion 353 as described above. As a result, the three-dimensional object printing apparatus 100 acquires the corrected path information Da and the timing information Db.

As described above, the control method of the three-dimensional object printing system 10 includes step S101, which is an example of the “workpiece information acquiring step”, and step S105, which is an example of the “path generating step”.

FIG. 6 is a diagram for describing the acquisition of the workpiece information Dw and the image information Dg. Each of the acquisition of the workpiece information Dw in the above-described step S101 and the acquisition of the image information Dg in the step S102 is performed by using an image UI, which is a graphical user interface (GUI) image illustrated in FIG. 6. The image UI illustrated in FIG. 6 is an example, and the present disclosure is not limited thereto.

The image UI includes regions R1, R2, and R3 and buttons B1, B2, B3, and B4.

The region R1 is a region for selecting a job file in which the past setting contents are recorded by using the image UI. In the example illustrated in FIG. 6, the region R1 has buttons B11, B12, and B13.

The button B11 is a button for selecting one job file from a plurality of existing job files. The file name of the selected job file is displayed on the button B11 by operating the button B11. The button B12 is a button for reading the selected job file. The setting contents of the selected job file are reflected in the region R2 and the region R3 by operating the button B11. The button B13 is a button for designating the file name of the file when creating a new job file. A new job file can be created by operating the button B13.

The region R2 is a region for selecting the workpiece W. In the example illustrated in FIG. 6, the region R2 has a region R2a and buttons B21 and B22.

The region R2a is a region for preview-displaying the image of the selected workpiece W. The button B21 is a button for selecting one workpiece information Dw from the plurality of pieces of workpiece information Dw. By operating the button B21, the file name of the selected workpiece information Dw is displayed on the button B21, and the preview image of the selected workpiece information Dw is displayed in the region R2a. The button B22 is a button for reading the selected workpiece information Dw. The selected workpiece information Dw is acquired by the acquisition portion 351 in step S101 by operating the button B22.

The region R3 is a region for setting the image information Dg for each surface of the workpiece W to be printed. Here, the surface of the workpiece W to be printed is extracted based on the shape indicated by the workpiece information Dw, and the display is performed in the region R3 according to the number of surfaces to be printed. In the example illustrated in FIG. 6, the region R3 has regions R3-1, R3-2, and R3-3 corresponding to the surfaces of the workpiece W, which are different from each other and are to be printed. Each of the regions R3-1, R3-2, and R3-3 is a region for setting the image information Dg for the corresponding surface to be printed, and includes a region R3a and buttons B31 and B32.

The region R3a is a region for displaying a preview of the image of the selected image information Dg. The button B31 is a button for selecting one piece of image information Dg from the plurality of pieces of image information Dg. By operating the button B31, the file name of the selected image information Dg is displayed on the button B31, and the preview image of the selected image information Dg is displayed in the region R3a. Further, the selected image information Dg is acquired by the acquisition portion 351 in step S102 by operating the button B31. The button B32 is a button for canceling the selection of the image information Dg. The selection of the image information Dg is cancelled by operating the button B32.

The button B1 is a button for creating the path information Da and the print data Img with the setting contents input in the region R2 and the region R3. The above-described step S103 is executed by operating the button B1. As a result, the path information Da and the print data Img are acquired by the three-dimensional object printing apparatus 100 by executing steps S104 to S107 by the server 300.

The button B2 is a button for executing a preparatory operation using the acquired path information Da and the print data Img. Step S108 is executed in a state where the preparatory operation is executed by operating the button B2.

The button B3 is a button for executing the printing operation using the acquired path information Da and the print data Img. Step S108 is executed in a state where the printing operation is executed by operating the button B3.

The button B4 is a button for saving the job file of the setting contents input in the region R2 and the region R3. The job file of the setting contents input in the region R2 and the region R3 is stored in the storage circuit 7a by operating the button B4.

In the above three-dimensional object printing system 10, the print path is generated by the server 300, and thus the burden on the user of the three-dimensional object printing apparatus 100 can be reduced. Further, since the server 300 is communicatively connected to the three-dimensional object printing apparatus 100, an appropriate print path can be applied from the server 300 to the three-dimensional object printing apparatus 100 in a timely manner. As a result, the print quality on the three-dimensional workpiece W can be improved.

Further, as described above, the server 300 acquires the robot information Dr regarding the robot 2 and corrects the print path indicated by the path information Da based on the robot information Dr. As a result, the print path can be corrected in consideration of the operation error of the robot 2. As a result, the print quality can be improved.

Further, as described above, the robot information Dr includes the individual information Dr1 for identifying the robot 2 and the performance information Dr2 regarding the performance of the robot 2. The server 300 includes a storage circuit 340 which is an example of a “storage portion”. The storage circuit 340 stores the robot information Dr. The server 300 corrects the print path indicated by the path information Da based on the robot information Dr. Therefore, the print path can be appropriately corrected according to the performance of each robot 2 based on the performance information Dr2 after the robot 2 is specified based on the individual information Dr1. As a result, the print path can be more accurately corrected. Further, since the robot information Dr is stored in the storage circuit 340 of the server 300, it is not necessary to store the robot information Dr in the three-dimensional object printing apparatus 100. In addition, by accumulating the robot information Dr in the storage circuit 340 of the server 300, added values, such as condition monitoring of the three-dimensional object printing apparatus 100 or malfunction addressing, can also be provided from the server 300.

Further, as described above, the three-dimensional object printing apparatus 100 includes the operation detection portion 4 that detects the operation of the robot 2. The server 300 acquires the operation information Dm regarding the operation of the robot 2 from the operation detection portion 4, and corrects the print path indicated by the path information Da based on the operation information Dm. As a result, the print path indicated by the path information Da can be corrected in consideration of the actual operation of the robot 2. As a result, the print quality can be further improved.

Further, as described above, the server 300 acquires the operation information Dm from the operation detection portion 4 during the period in which the three-dimensional object printing apparatus 100 is performing printing. As a result, the print path indicated by the path information Da can be corrected in consideration of the operation of the robot 2 at the time of actual printing. As a result, the print quality can be improved without reducing the throughput.

Further, as described above, the three-dimensional object printing apparatus 100 executes the preparatory operation of moving the print head 3 along the print path indicated by the path information Da without discharging the liquid from the print head 3. The server 300 acquires the operation information Dm detected by the operation detection portion 4 during the period in which the preparatory operation is being executed. As a result, the print path indicated by the path information Da can be corrected in consideration of the operation of the robot 2 at the time of actual printing without actually performing printing. As a result, the print quality can be stably improved.

Further, as described above, the server 300 includes the storage circuit 340 which is an example of the “storage portion”. The storage circuit 340 stores the operation information Dm. The server 300 calculates a change over time of the operation of the robot 2 based on the operation information Dm, and corrects the print path indicated by the path information Da based on the change over time. As a result, even when the operation of the robot 2 changes due to the change over time, the print path indicated by the path information Da can be appropriately corrected. As a result, the print quality can be stably improved.

Further, as described above, the operation detection portion 4 detects the displacement of the print head 3. The server 300 corrects the discharge timing of the print head 3 based on the operation information Dm. As a result, the discharge timing of the print head 3 is corrected, and thus the print quality can be improved while the burden on the user is reduced.

Further, as described above, the server 300 acquires the head information Dh regarding the print head 3, and corrects the discharge timing indicated by the timing information Db based on the operation information Dm and the head information Dh. The discharge timing indicated by the timing information Db is the discharge timing of the print head 3. As described above, the discharge timing is corrected for each print head 3, and thus the print quality can be stably improved as compared with the aspect in which the discharge timing is commonly corrected.

Further, as described above, the server 300 acquires the environment information Ds1 regarding the environment in which the robot 2 is installed, and corrects the print path indicated by the path information Da based on the result of the simulation using the environment information Ds1. As a result, the print path indicated by the path information Da can be appropriately corrected in consideration of the installation environment of the robot 2.

Further, as described above, the server 300 creates a divided image obtained by dividing the print image to be printed on the workpiece W based on the print path indicated by the corrected path information Da. As a result, the server 300 creates the divided image, and thus the burden on the user can be reduced.

In addition, as described above, the server 300 includes the storage circuit 340 which is an example of the “storage portion”. The storage circuit 340 stores the print path indicated by the corrected path information Da. The server 300 creates a divided image obtained by dividing a print image to be printed on the workpiece W based on the workpiece information Dw and the print path indicated by the path information Da. As a result, the print path indicated by the path information Da once generated can be applied to another image. As a result, the processing efficiency for correcting the print path indicated by the path information Da in the server 300 can be improved.

Further, as described above, the server 300 acquires information in which color information regarding the color of the workpiece W and the workpiece information Dw are integrated, and divides the information into the color information and the workpiece information Dw. As a result, the shape data with an image can be used as the information.

Further, as described above, the server 300 stores the standard coordinate system which is the coordinate system of the three-dimensional object printing apparatus 100. The server 300 acquires the position information Dal regarding the positional relationship between the workpiece W and the mount portion BW on which the workpiece W is mounted, and corrects the coordinate system of the workpiece W mounted on the mount portion BW based on the position information Dal and the standard coordinate system. As a result, even when the correspondence relationship between the position at which the workpiece W is mounted and the standard coordinate system is shifted, the standard coordinate system can be corrected while reducing the burden on the user.

### 2. SECOND EMBODIMENT

Hereinafter, a second embodiment of the present disclosure will be described. In the embodiment illustrated below, elements having the same effects and functions as those of the first embodiment will be given the reference numerals used in the description of the first embodiment, and each of the detailed descriptions thereof will be appropriately omitted.

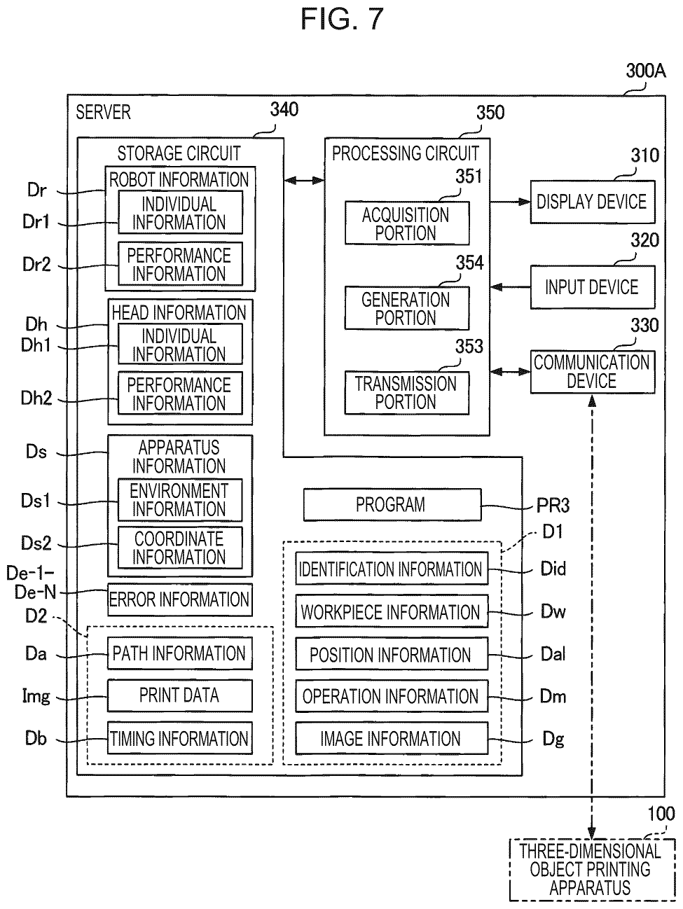

FIG. 7 is a schematic diagram illustrating a configuration example of a server 300A used in the three-dimensional object printing system according to the second embodiment. The server 300A is configured in the same manner as the server 300 of the first embodiment, except that a program PR3 is used instead of the program PR2.

The processing circuit 350 of the server 300A functions as the acquisition portion 351, a generation portion 354, and the transmission portion 353 by reading the program PR2 from the storage circuit 340 and executing the program PR2. The generation portion 354 is the same as the generation portion 352 of the first embodiment, except that a function of correcting the path information Da based on the error information De-1 to De-N is added. N is a natural number of 1 or more. In the following, each of the error information De-1 to De-N may be referred to as error information De without distinction.

Each of the error information De-1 to De-N is information regarding an error in the operation of the robot 2 when the print head 3 is moved along the virtual path indicated by the path information Da. The error information De-1 to De-N is acquired in advance before the shipment of the three-dimensional object printing apparatus 100 and stored in the storage circuit 340.

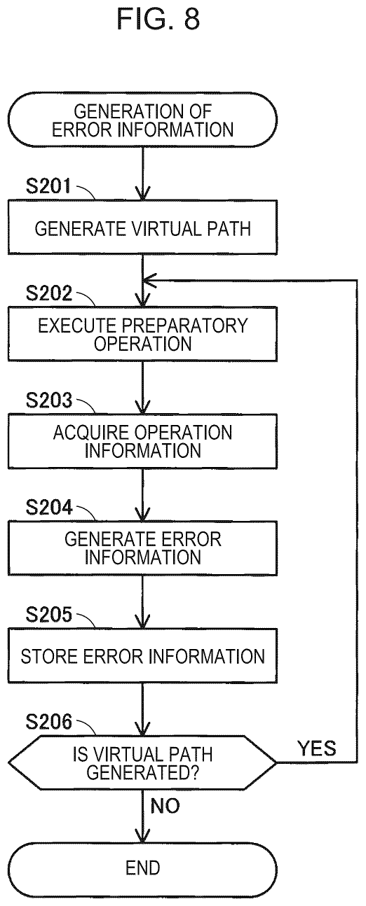

FIG. 8 is a flowchart illustrating generation of the error information De-1 to De-N in the second embodiment. When generating the error information De-1 to De-N, first, as illustrated in FIG. 8, in step S201, a path assumed as a print path is generated as a virtual path.

Next, in step S202, a preparatory operation of the three-dimensional object printing apparatus 100 before shipment is performed by using the generated virtual path. In this preparatory operation, the print head 3 moves at a movement speed determined for each virtual path.

Next, in step S203, the operation information Dm is acquired based on the detection result of the operation detection portion 4 during the execution of the preparatory operation. Here, for example, the operation information Dm is acquired by detecting the operation detection portion 4 at a plurality of points on the virtual path.

Next, in step S204, the error information De-k is generated using the obtained operation information Dm. k is a natural number of 1 or more and N or less.

Next, in step S205, the error information De-k is stored in the storage circuit 340.

Next, in step S206, it is determined whether or not to generate a path assumed as another print path as a virtual path.

When another path assumed as a print path is generated as a virtual path (step S206: YES), after a virtual path different from the already generated virtual path is generated, the above-described step S202 is executed. As a result, the error information De-1 to De-N corresponding to the N virtual paths is stored in the storage circuit 340.

When there is no other path assumed as a print path, the processing is ended (step S206: NO).

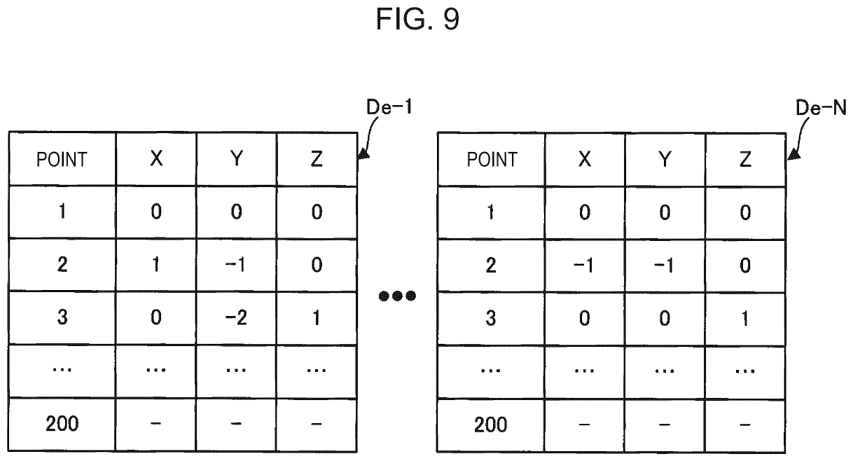

FIG. 9 is a diagram for describing the error information De-1 to De-N for each virtual path. FIG. 9 illustrates an example of the error information De-1 to De-N. In the example illustrated in FIG. 9, the deviation of each of the coordinate values of the X axis, the Y axis, and the Z axis of the position indicated by the operation information Dm with respect to the virtual path is indicated as an error for each of the 200 points on the virtual path in each of the error information De-1 to De-N.

As described above, in the present embodiment, the error information De-1 to De-N described above is already stored in the storage circuit 340 before the three-dimensional object printing apparatus 100 is shipped, and the path information Da can be corrected even after the three-dimensional object printing apparatus 100 is shipped without executing the preparatory operation. Hereinafter, this point will be described in detail.

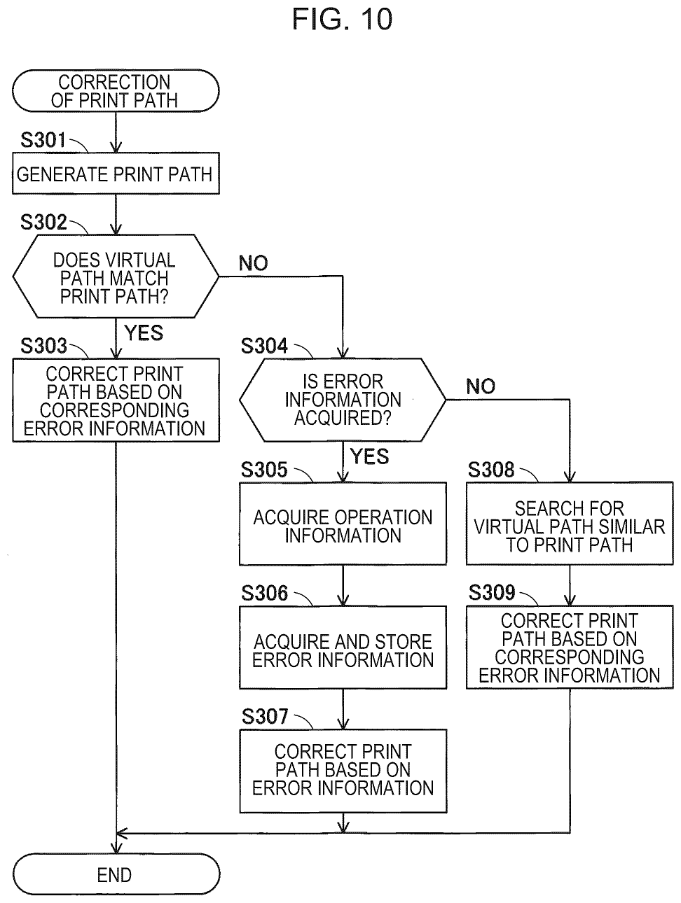

FIG. 10 is a flowchart illustrating correction of the print path in the second embodiment. In the present embodiment, when the print path indicated by the path information Da is corrected, first, in step S301, the print path indicated by the path information Da is generated, as in the first embodiment.

Next, in step S302, it is determined whether or not there is a virtual path that matches the generated print path among the plurality of virtual paths described above.

When there is a virtual path that matches the generated print path (step S302: YES), in step S303, the print path indicated by the path information Da is corrected based on the error information De corresponding to the virtual path.

On the other hand, when there is no virtual path matching the generated print path (step S302: NO), it is determined whether or not to further acquire the error information De in step S304. The determination may be made based on, for example, an instruction based on an operation of the user, or regarding the difference between the generated print path and the virtual path, the difference may be made by determining that the error information De is acquired when the difference is equal to or greater than a predetermined value.

Further, when the error information De is acquired (step S304: YES), the operation information Dm is acquired in step S305, as in step S203 described above. Thereafter, in step S306, the error information De is acquired and stored in the same manner as in steps S204 and S205 described above. Then, in step S307, the print path indicated by the path information Da is corrected based on the error information De.

On the other hand, when the error information De is not acquired (step S304: NO), in step S308, the virtual path that is most similar to the generated print path is searched from the plurality of virtual paths described above.

Then, in step S309, the print path indicated by the path information Da is corrected based on the error information De corresponding to the most similar virtual path.

According to the above-described second embodiment, the print quality of the three-dimensional workpiece W can be improved while reducing the burden on the user. In the present embodiment, as described above, the server 300A includes the storage circuit 340 which is an example of the “storage portion”. The storage circuit 340 stores the error information De-1 to De-N regarding the error in the operation of the robot 2 when the print head 3 is moved along the virtual path. The server 300 corrects the print path indicated by the path information Da based on the error information De-1 to De-N. As a result, the user of the three-dimensional object printing apparatus 100 does not need to perform the preparatory operation, and thus the throughput can be improved.

Further, as described above, the server 300A determines whether or not the print path indicated by the path information Da matches the virtual path, and when it is determined that the print path indicated by the path information Da matches the virtual path (step S302: YES), the server 300A corrects the print path indicated by the path information Da based on the error information De corresponding to the virtual path (step S303). As a result, the correction processing of the print path indicated by the path information Da can be quickly performed by referring to the information stored in advance in the storage circuit 340.

Furthermore, as described above, the three-dimensional object printing apparatus 100 includes the operation detection portion 4 that detects the operation of the robot 2. When the server 300A determines that the print path indicated by the path information Da does not match the virtual path (step S302: NO), the server 300A acquires the operation information Dm regarding the operation of the robot 2 from the operation detection portion 4 (step S305), and corrects the print path indicated by the path information Da based on the operation information Dm (steps $306 and $307). As a result, the print quality can be improved as compared with the aspect of using the error information De corresponding to the virtual path.

Further, as described above, when the server 300A determines that the print path indicated by the path information Da does not match the virtual path (step S302: NO), the server 300A searches for the virtual path similar to the print path indicated by the path information Da (step S308), and corrects the print path indicated by the path information Da based on the error information De corresponding to the virtual path (step S309). As a result, the correction processing of the print path indicated by the path information Da can be quickly performed by referring to the information stored in advance in the storage circuit 340.

### 3. MODIFICATION EXAMPLES

Above, the three-dimensional object printing system of the present disclosure was described based on the illustrated embodiments, but the present disclosure is not limited to these. Further, the configuration of each portion of the present disclosure can be replaced with any configuration that exhibits the same functions as that of the above-described embodiment, or any configuration can be added.

### 3-1. Modification Example 1

In the above-described embodiment, the configuration in which the server 300 is a cloud server is exemplified, but the configuration is not limited thereto. For example, the server 300 may be a server other than a cloud server or a virtual server, or may be an on-premises server.

### 4. ADDITIONAL NOTES

A summary of the present disclosure is added below.

(Additional Note 1) According to a first aspect of the present disclosure, there is provided a three-dimensional object printing system including: a three-dimensional object printing apparatus including a print head that discharges a liquid toward a three-dimensional workpiece, and a robot that holds the print head; and a server communicatively connected to the three-dimensional object printing apparatus, in which the server acquires workpiece information regarding the workpiece, and generates, based on the workpiece information, a print path that is a path on which the print head moves with respect to the workpiece.

In the above aspect, the print path is generated by the server, and thus the burden on the user of the three-dimensional object printing apparatus can be reduced. Further, since the server is communicatively connected to the three-dimensional object printing apparatus, an appropriate print path can be applied from the server to the three-dimensional object printing apparatus in a timely manner. As a result, the print quality on the three-dimensional workpiece can be improved.

(Additional Note 2) In a second aspect which is a preferred example of the first aspect, the server acquires robot information regarding the robot, and corrects, based on the robot information, the print path. In the above aspect, the print path can be corrected in consideration of the operation error of the robot. As a result, the print quality can be improved.

(Additional Note 3) In a third aspect which is a preferred example of the second aspect, the robot information includes individual information for identifying the robot and performance information regarding performance of the robot, and the server includes a storage portion that stores the robot information, and corrects, based on the robot information, the print path. In the above aspect, the print path can be appropriately corrected according to the performance of each robot based on the performance information after specifying the robot based on the individual information. As a result, the print path can be more accurately corrected. Further, since the robot information is stored in the storage portion of the server, it is not necessary to store the robot information in the three-dimensional object printing apparatus. In addition, by accumulating the robot information in the storage portion of the server, added values, such as condition monitoring of the three-dimensional object printing apparatus or malfunction addressing, can also be provided from the server.

(Additional Note 4) In a fourth aspect which is a preferred example of any one of the first to third aspects, the three-dimensional object printing apparatus further includes an operation detection portion that detects an operation of the robot, and the server acquires operation information regarding the operation of the robot from the operation detection portion, and corrects, based on the operation information, the print path. In the above aspect, the print path can be corrected in consideration of the actual operation of the robot. As a result, the print quality can be further improved.

(Additional Note 5) In a fifth aspect which is a preferred example of the fourth aspect, the server acquires the operation information from the operation detection portion during a period in which the three-dimensional object printing apparatus is performing printing. In the above aspect, the print path can be corrected in consideration of the operation of the robot at the time of actual printing. As a result, the print quality can be improved without reducing the throughput.

(Additional Note 6) In a sixth aspect which is a preferred example of the fourth aspect, the three-dimensional object printing apparatus executes a preparatory operation of moving the print head along the print path without discharging the liquid from the print head, and the server acquires the operation information by detection of the operation detection portion during an execution period of the preparatory operation. In the above aspect, the print path can be corrected in consideration of the operation of the robot at the time of actual printing without actually performing the printing. As a result, the print quality can be stably improved.

(Additional Note 7) In a seventh aspect which is a preferred example of the fourth aspect, the server includes a storage portion that stores the operation information, calculates, based on the operation information, a change over time of the operation of the robot, and corrects, based on the change over time, the print path. In the above aspect, even when the operation of the robot changes over time, the print path can be appropriately corrected. As a result, the print quality can be stably improved.

(Additional Note 8) In an eighth aspect which is a preferred example of the first to seventh aspects, the server includes a storage portion that stores error information regarding error of an operation of the robot when the print head is moved along a virtual path, and corrects, based on the error information, the print path. In the above aspect, the user of the three-dimensional object printing apparatus does not need to perform the preparatory operation, and thus the throughput can be improved.

(Additional Note 9) In a ninth aspect which is a preferred example of the eighth aspect, the server determines whether or not the print path matches the virtual path, and when it is determined that the print path matches the virtual path, corrects, based on the error information corresponding to the virtual path, the print path. In the above aspect, the correction processing of the print path can be quickly performed by referring to the information stored in the storage portion.

(Additional Note 10) In a tenth aspect which is a preferred example of the eighth aspect, the three-dimensional object printing apparatus further includes an operation detection portion that detects the operation of the robot, and when it is determined that the print path does not match the virtual path, the server acquires operation information regarding the operation of the robot from the operation detection portion, and corrects, based on the operation information, the print path. In the above aspect, the print quality can be improved as compared with the aspect of using the error information corresponding to the virtual path.

(Additional Note 11) In an eleventh aspect which is a preferred example of the eighth aspect, when it is determined that the print path does not match the virtual path, the server searches for the virtual path similar to the print path, and corrects, based on the error information corresponding to the virtual path, the print path. In the above aspect, the correction processing of the print path can be quickly performed by referring to the information stored in the storage portion.

(Additional Note 12) In a twelfth aspect which is a preferred example of any one of the fourth to seventh aspects, the operation detection portion detects a displacement of the print head, and the server corrects, based on the operation information, a discharge timing of the print head. In the above aspect, the discharge timing of the print head is corrected, and thus the print quality can be improved while the burden on the user is reduced.

(Additional Note 13) In a thirteenth aspect which is a preferred example of the twelfth aspect, the server acquires head information regarding the print head, and corrects, based on the operation information and the head information, the discharge timing of the print head. In the above aspect, the discharge timing is corrected for each print head, and thus the print quality can be stably improved as compared with the aspect in which the discharge timing is commonly corrected.

(Additional Note 14) In a fourteenth aspect which is a preferred example of the second aspects, the server acquires environment information regarding an environment in which the robot is installed, and corrects, based on a result of a simulation using the environment information, the print path. In the above aspect, the print path can be appropriately corrected in consideration of the installation environment of the robot.

(Additional Note 15) In a fifteenth aspect which is a preferred example of any one of the first to fourteenth aspects, the server creates, based on the print path after correction, a divided image obtained by dividing a print image to be printed on the workpiece. In the above aspect, the server creates the divided image, and thus the burden on the user can be reduced.

(Additional Note 16) In a sixteenth aspect which is a preferred example of the fifteenth aspect, the server includes a storage portion that stores the print path after correction, and creates, based on the workpiece information and the print path, a divided image obtained by dividing a print image to be printed on the workpiece. In the above aspect, the print path generated once can be applied to another image. As a result, the processing efficiency for correcting the print path on the server can be improved.

(Additional Note 17) In a seventeenth aspect which is a preferred example of any one of the first to sixteenth aspects, the server acquires information in which color information regarding color of the workpiece and the workpiece information are integrated, and divides the information into the color information and the workpiece information. In the above aspect, the shape data with an image can be used as the information.

(Additional Note 18) In an eighteenth aspect which is a preferred example of any one of the first to seventeenth aspects, the server stores a standard coordinate system which is a coordinate system of the three-dimensional object printing apparatus, acquires position information regarding a positional relationship between the workpiece and a mount portion on which the workpiece is mounted, and corrects, based on the position information and the standard coordinate system, a coordinate system of the workpiece mounted on the mount portion. In the above aspect, even when the correspondence relationship between the position at which the workpiece is mounted and the standard coordinate system is shifted, the standard coordinate system can be corrected while reducing the burden on the user.

(Additional Note 19) According to a preferred example of the present disclosure, there is provided a control method of a three-dimensional object printing system including a three-dimensional object printing apparatus and a server, the three-dimensional object printing apparatus including a print head that discharges a liquid toward a three-dimensional workpiece, and a robot that holds the print head, and the server being communicatively connected to the three-dimensional object printing apparatus, the method including: a workpiece information acquiring step of acquiring workpiece information regarding the workpiece; and a path generating step of generating, based on the workpiece information, a print path that is a path on which the print head moves with respect to the workpiece.

In the above aspect, the print path is generated by the server, and thus the burden on the user of the three-dimensional object printing apparatus can be reduced. Further, since the server is communicatively connected to the three-dimensional object printing apparatus, an appropriate print path can be applied from the server to the three-dimensional object printing apparatus in a timely manner. As a result, the print quality on the three-dimensional workpiece can be improved.

(Additional Note 20) According to a preferred example of the present disclosure, there is provided a three-dimensional object printing apparatus including: a print head that discharges a liquid toward a three-dimensional workpiece; a robot that holds the print head; and a control portion that is communicatively connected to a server, in which the control portion transmits workpiece information regarding the workpiece to the server, and receives, from the server, a print path that is a path on which the print head moves with respect to the workpiece.

In the above aspect, the print path is generated by the server, and thus the burden on the user of the three-dimensional object printing apparatus can be reduced. Further, since the server is communicatively connected to the three-dimensional object printing apparatus, an appropriate print path can be applied from the server to the three-dimensional object printing apparatus in a timely manner. As a result, the print quality on the three-dimensional workpiece can be improved.

(Additional Note 21) According to a preferred example of the present disclosure, there is provided a three-dimensional object printing system including: a three-dimensional object printing apparatus including a print head that discharges a liquid toward a three-dimensional workpiece, a robot that holds the print head, and an operation detection portion that detects an operation of the robot; and a server communicatively connected to the three-dimensional object printing apparatus, in which the server acquires displacement information regarding displacement of the print head from the operation detection portion, and corrects, based on the displacement information, a discharge timing of the print head.

In the above aspect, since the discharge timing is corrected by the server, the burden on the user of the three-dimensional object printing apparatus can be reduced. Further, since the server is communicatively connected to the three-dimensional object printing apparatus, an appropriate discharge timing can be applied from the server to the three-dimensional object printing apparatus in a timely manner. As a result, the print quality on the three-dimensional workpiece can be improved.

What is claimed is:

1. A three-dimensional object printing system comprising:
a three-dimensional object printing apparatus including a print head that discharges a liquid toward a three-dimensional workpiece, and a robot that holds the print head; and
a server communicatively connected to the three-dimensional object printing apparatus, wherein
the server
acquires workpiece information regarding the workpiece, and
generates, based on the workpiece information, a print path that is a path on which the print head moves with respect to the workpiece.

2. The three-dimensional object printing system according to claim 1, wherein
the server
acquires robot information regarding the robot, and
corrects, based on the robot information, the print path.

3. The three-dimensional object printing system according to claim 2, wherein
the robot information includes individual information for identifying the robot and performance information regarding performance of the robot, and
the server
includes a storage portion that stores the robot information, and
corrects, based on the robot information, the print path.

4. The three-dimensional object printing system according to claim 1, wherein
the three-dimensional object printing apparatus further includes an operation detection portion that detects an operation of the robot, and
the server
acquires operation information regarding the operation of the robot from the operation detection portion, and
corrects, based on the operation information, the print path.

5. The three-dimensional object printing system according to claim 4, wherein
the server acquires the operation information from the operation detection portion during a period in which the three-dimensional object printing apparatus is performing printing.

6. The three-dimensional object printing system according to claim 4, wherein
the three-dimensional object printing apparatus executes a preparatory operation of moving the print head along the print path without discharging the liquid from the print head, and
the server acquires the operation information by detection of the operation detection portion during an execution period of the preparatory operation.

7. The three-dimensional object printing system according to claim 4, wherein
the server
includes a storage portion that stores the operation information,
calculates, based on the operation information, a change over time of the operation of the robot, and
corrects, based on the change over time, the print path.

8. The three-dimensional object printing system according to claim 1, wherein
the server
includes a storage portion that stores error information regarding error of an operation of the robot when the print head is moved along a virtual path, and
corrects, based on the error information, the print path.

9. The three-dimensional object printing system according to claim 8, wherein
the server
determines whether or not the print path matches the virtual path, and
when it is determined that the print path matches the virtual path, corrects, based on the error information corresponding to the virtual path, the print path.

10. The three-dimensional object printing system according to claim 8, wherein
the three-dimensional object printing apparatus further includes an operation detection portion that detects the operation of the robot, and
when it is determined that the print path does not match the virtual path,
the server
acquires operation information regarding the operation of the robot from the operation detection portion, and
corrects, based on the operation information, the print path.

11. The three-dimensional object printing system according to claim 8, wherein
when it is determined that the print path does not match the virtual path,
the server
searches for the virtual path similar to the print path, and
corrects, based on the error information corresponding to the virtual path, the print path.

12. The three-dimensional object printing system according to claim 4, wherein
the operation detection portion detects a displacement of the print head, and
the server corrects, based on the operation information, a discharge timing of the print head.

13. The three-dimensional object printing system according to claim 12, wherein
the server
acquires head information regarding the print head, and
corrects, based on the operation information and the head information, the discharge timing of the print head.

14. The three-dimensional object printing system according to claim 2, wherein
the server
acquires environment information regarding an environment in which the robot is installed, and
corrects, based on a result of a simulation using the environment information, the print path.

15. The three-dimensional object printing system according to claim 1, wherein
the server creates, based on the print path after correction, a divided image obtained by dividing a print image to be printed on the workpiece.

16. The three-dimensional object printing system according to claim 15, wherein
the server
includes a storage portion that stores the print path after correction, and
creates, based on the workpiece information and the print path, a divided image obtained by dividing a print image to be printed on the workpiece.

17. The three-dimensional object printing system according to claim 1, wherein
the server
acquires information in which color information regarding color of the workpiece and the workpiece information are integrated, and
divides the information into the color information and the workpiece information.

18. The three-dimensional object printing system according to claim 1, wherein
the server
stores a standard coordinate system which is a coordinate system of the three-dimensional object printing apparatus,
acquires position information regarding a positional relationship between the workpiece and a mount portion on which the workpiece is mounted, and
corrects, based on the position information and the standard coordinate system, a coordinate system of the workpiece mounted on the mount portion.

19. A control method of a three-dimensional object printing system including a three-dimensional object printing apparatus and a server, the three-dimensional object printing apparatus including a print head that discharges a liquid toward a three-dimensional workpiece, and a robot that holds the print head, and the server being communicatively connected to the three-dimensional object printing apparatus, the method comprising:
a workpiece information acquiring step of acquiring workpiece information regarding the workpiece; and
a path generating step of generating, based on the workpiece information, a print path that is a path on which the print head moves with respect to the workpiece.

20. A three-dimensional object printing apparatus comprising:
a print head that discharges a liquid toward a three-dimensional workpiece;
a robot that holds the print head; and
a control portion that is communicatively connected to a server, wherein
the control portion
transmits workpiece information regarding the workpiece to the server, and
receives, from the server, a print path that is a path on which the print head moves with respect to the workpiece.
